(19) United States
(12) Patent Application Publication
(10) Pub. No.: US 2025/0034949 A1
(43) Pub. Date: Jan. 30, 2025

(54) CONDUITS FOR FEEDING AIR TO SMALL BEARINGS OF JOURNAL AREA OF ROTARY DRILL BIT

(71) Applicant: Caterpillar Inc., Peoria, IL (US)

(72) Inventors: Swetha SURESH, Chennai (IN); Ebi BERNARD, Arakkonam (IN); Tamilmurasu ANNADURAI, Pudukkottai (IN)

(73) Assignee: Caterpillar Inc., Peoria, IL (US)

(21) Appl. No.: 18/771,488

(22) Filed: Jul. 12, 2024

Related U.S. Application Data
(60) Provisional application No. 63/516,329, filed on Jul. 28, 2023.

(51) Int. Cl. E21B 10/22; F16C 33/10

(52) U.S. Cl. CPC E21B 10/22; F16C 33/105; F16C 2352/00

(57) ABSTRACT

A rotary drill bit includes a plurality of rotating cones each including a plurality of cutting tips, and a plurality of legs on which the plurality of cones are respectively supported. Each leg includes a journal area configured to rotatably support the respective cone, a primary conduit extending internally within the leg and configured to receive air from an air compressor, a first journal conduit downstream from the primary conduit and extending to a first air orifice of the journal area, and at least one second journal conduit downstream from the primary conduit and extending to at least one corresponding second air orifice of the journal area. A ratio of a cross-sectional diameter of the first journal conduit to a cross-sectional diameter of at least one of the second journal conduits is in a range of about 1 to about 1.4.

### CROSS-REFERENCE TO RELATED APPLICATION

This application claims the benefit of priority to U.S. Provisional Patent Application No. 63/516,329, filed on Jul. 28, 2023, the entirety of which is incorporated herein by reference.

### TECHNICAL FIELD

The present disclosure relates generally to drilling machines, and more particularly, to a rotary drill bit with air conduits for supplying cooling air to a journal area of the drill bit.

### BACKGROUND

Surface drilling is a necessary operation in many industries including mining, oil and gas extraction, construction, geothermal drilling, and many others. Surface drilling is performed with drilling machines that use various types of drill bits to generate cutting forces to break rock, soil, clay, etc. One class of drill bits, known as rotary drill bits, utilize one or more rotating cutterheads to perform a cutting operation. The rotary drill bit is mounted to the end of a drill string of a drilling machine.

Drilling generates substantial heat, which can damage and shorten the life of various components of the drill bit. For example, heat can reduce the useful life of bearings of the rotary drill bit. To combat heat, rotary drill bits utilize a cooling fluid (either liquid or gas) to cool the bearings and other components of the drill bit. In some configurations, an air compressor of the drilling machine provides air to cool components (e.g. bearings and thrust surfaces) of the drill bit. Typically, the drill bit includes a plurality of conduits to divide the air from the drill string and direct air to pertinent areas of the drill bit for cooling. In other configurations, the bearings are sealed and cooled with lubrication.

Rotary drill bits typically include multiple rows of bearings (e.g. cylindrical roller bearings and/or ball bearings) that should be kept cool to prevent premature wear or failure associated with overheating.

U.S. Pat. No. 8,337,085, issued to Nagaraj et al. (“the '085 patent”), describes a thrust bearing system for a roller cone rock bit including a roller cone disposed on a leg having an air channel therethrough. A primary thrust bearing surface on the leg contacts a corresponding primary bearing surface on the roller cone. The primary thrust bearing surface on the leg includes at least one air circulation port in fluid communication with the air channel. A secondary thrust bearing surface on the leg contacts a corresponding secondary bearing surface on the roller cone. The secondary thrust bearing surface on the leg includes at least two air circulation ports in communication with the air channel. The bit further includes radial load bearing surfaces that support roller bearings and ball bearings.

The '085 patent describes cooling components of the rock bit with air from the air channel. However, the '085 patent does not describe sizes of the air channel or the relative proportions of the air that flows to the components, such as the roller bearings and ball bearings. In the arrangement illustrated in the '085 patent, the roller bearings nearest the tip of the cones may receive insufficient air and/or unevenly distributed air causing heat-related wear and ultimately failure.

The systems and methods of the present disclosure may address or solve one or more of the problems set forth above and/or other problems in the art. The scope of the current disclosure, however, is defined by the attached claims, and not by the ability to solve any specific problem.

### SUMMARY

An aspect of the present disclosure a rotary drill bit for a drilling system including a drilling machine having an air compressor to supply air to the rotary drill bit. The rotary drill bit includes a plurality of rotating cones each including a plurality of cutting tips, and a plurality of legs on which the plurality of cones are respectively supported. Each leg includes a journal area configured to rotatably support the respective cone, a primary conduit extending internally within the leg and configured to receive air from the air compressor, a first journal conduit downstream from the primary conduit and extending to a first air orifice of the journal area, and at least one second journal conduit downstream from the primary conduit and extending to at least one corresponding second air orifice of the journal area. A ratio of a cross-sectional diameter of the first journal conduit to a cross-sectional diameter of at least one of the second journal conduits is in a range of about 1 to about 1.4.

Another aspect of the present disclosure is directed to a method for operating a rotary drill bit including a cone rotatably supported on a leg. The method includes rotating the cone relative to a journal area of the leg, supplying air from an air compressor to a primary conduit within the leg, supplying air from the primary conduit to a first journal conduit and a second journal conduit within the leg, cooling at least part of the journal area with air from the first journal conduit, and cooling at least part of the journal area with air from the second journal conduit. A ratio of a cross-sectional diameter of the first journal conduit to a cross-sectional diameter of the second journal conduit is in a range of about 1 to about 1.4.

Yet another aspect of the present disclosure is directed to a drilling system including a drilling machine including an air compressor, a drill string extending from the drilling machine, and a rotary drill bit connected to an end of the drill string and receiving air from the air compressor via the drill string. The rotary drill bit includes a plurality of legs each including a journal area configured to rotatably support a cone, a primary conduit extending internally within the leg and configured to receive air from the air compressor, a first journal conduit downstream from the primary conduit and extending to a first air orifice of the journal area, and a second journal conduit downstream from the primary conduit and extending to a second air orifice of the journal area. A ratio of a cross-sectional diameter of the first journal conduit to a cross-sectional diameter of the second journal conduit is in a range of about 1 to about 1.4.

### BRIEF DESCRIPTION OF THE DRAWINGS

The accompanying drawings, which are incorporated in and constitute a part of this specification, illustrate various exemplary embodiments and together with the description, serve to explain the principles of the disclosure.

FIG. 1 illustrates a schematic side view of a drilling machine including a drill string and a rotary drill bit, according to aspects of the present disclosure.

FIG. 2A illustrates a perspective view of a rotary drill bit of the drilling machine of FIG. 1.

FIG. 2B illustrates a bottom view of the rotary drill bit of FIG. 2A.

FIG. 3 illustrates a partial cross-sectional view of the rotary drill bit of FIG. 2A taken along section marks A-A of FIG. 2A.

FIG. 4 illustrates a perspective view of a leg of the rotary drill bit of FIG. 2A with a cone removed.

FIG. 5 illustrates a perspective view of the leg of the rotary drill bit of FIG. 2A with the cone and bearings removed.

FIG. 6 illustrates a detail perspective view of a journal area of the leg of FIG. 5.

FIG. 7 illustrates a detail perspective view of a journal area of the leg of FIG. 5.

FIG. 8 is a chart illustrated relative percentage of air flow to bearings of the rotary drill bit of FIG. 2A.

FIG. 9 is a flow diagram of a method for operating the rotary drill bit of FIG. 2A.

### DETAILED DESCRIPTION

Both the foregoing general description and the following detailed description are exemplary and explanatory only and are not restrictive of the features, as claimed. As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. Further, relative terms, such as, for example, “about,” “substantially,” “generally,” and “approximately” are used to indicate a possible variation of ±10% in a stated value.

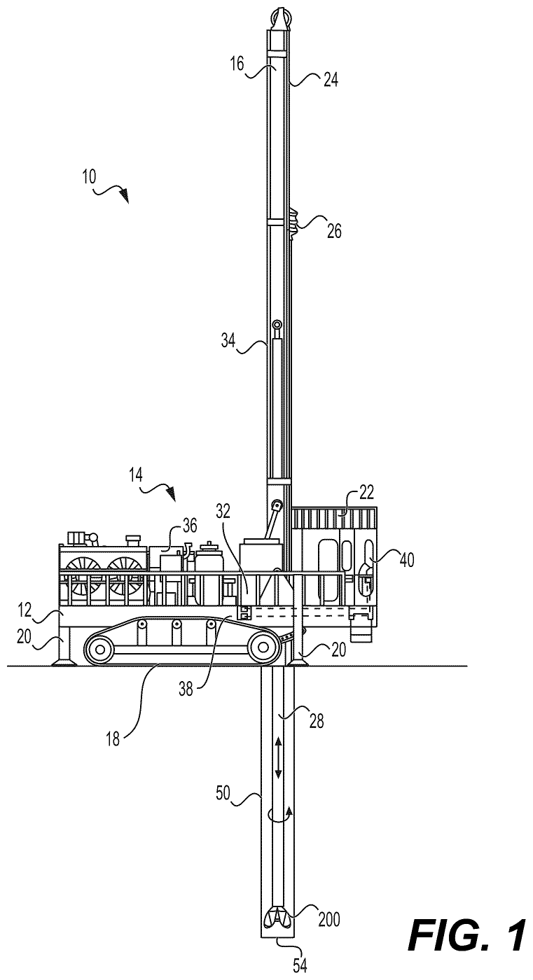

FIG. 1 illustrates a schematic side view of an exemplary drilling machine 10. The disclosure herein may be applicable to any type of drilling machine, however, reference will be made below particularly to a mobile blasthole drilling machine. As shown in FIG. 1, mobile drilling machine 10 may include a frame 12, machinery 14, and a drilling mast 16. Frame 12 may be supported on a ground surface by a transport mechanism, such as crawler tracks 18. Crawler tracks 18 may allow mobile drilling machine 10 to maneuver about the ground surface to a desired location for a drilling operation. Frame 12 may include one or more jacks 20 for supporting and leveling mobile drilling machine 10 on the ground surface during the drilling operation. Frame 12 may support machinery 14, which may include engines, motors, batteries, pumps, hydraulic fluid tanks, an air compressors 36 (shown schematically in FIG. 1) and/or any other equipment necessary to power and operate mobile drilling machine 10. Frame 12 may further support an operator cab 22, from which a user, or operator, may maneuver and control mobile drilling machine 10 via a user interfaces and displays 40.

As further shown in FIG. 1, drilling mast 16 may include a mast frame 24 which may support a drill motor assembly, or rotary head 26, movably mounted on the mast frame 24. Rotary head 26 may couple to, and may be controllable to rotate, a drill string 28 of drilling pipe segments on which a drill bit 200 may be mounted for down-the-hole drilling into the ground surface, as further described below.

Rotary head 26 may be any type of rotary head, such as a hydraulic rotary head or the like. Rotary head 26 may further include a hydraulic fluid line (not shown) for receiving hydraulic fluid. The hydraulic fluid may be used to rotate a shaft of rotary head 26 on which the drill string 28 is connected for rotating the drill string 28 (and thus rotating drill bit 200). The hydraulic fluid line of rotary head 26 may be coupled to a hydraulic valve 32 (shown schematically in FIG. 1) for controlling the amount, and flow rate, of the hydraulic fluid into rotary head 26. In the exemplary embodiment, hydraulic valve 32 may be located on the hydraulic fluid storage tank 38. However, hydraulic valve 32 may be located anywhere along the hydraulic fluid line of the rotary head 26, as necessary.

Drilling mast 16 may further include a hydraulic feed cylinder 34 (located within mast frame 24) connected to rotary head 26 via a cable and pulley system (not shown) for moving rotary head 26 up and down along the mast frame 24. As such, when hydraulic feed cylinder 34 is extended, hydraulic feed cylinder 34 may exert a force on rotary head 26 for pulling-down rotary head 26 along mast frame 24. Likewise, when hydraulic feed cylinder 34 is retracted, hydraulic feed cylinder 34 may exert a force on rotary head 26 for hoisting up rotary head 26 along mast frame 24. Thus, hydraulic feed cylinder 34 may be controllable to control rotary head 26 to move up and down the mast frame 24 such that drill bit 200 on drill string 28 may be pulled-down towards, and into, the ground surface or hoisted up from the ground surface. As used herein, the term “feed” in the context of the feed cylinder 34 includes movement of the drill string 28 in either direction (up or down). Hydraulic feed cylinder 34 may include hydraulic fluid lines (not shown) for receiving and conveying hydraulic fluid to and from feed cylinder 34. The hydraulic fluid may be used to actuate hydraulic cylinder 34 such that a rod of hydraulic cylinder 34 may be extended or retracted. The hydraulic fluid line of hydraulic cylinder 34 may be coupled to hydraulic valves for controlling the amount, and flow rate and pressure, of the hydraulic fluid into hydraulic cylinder 34. In the exemplary embodiment, hydraulic valve may be located on the hydraulic fluid storage tank 38. However, hydraulic valve may be located anywhere along the hydraulic fluid line of the hydraulic cylinder 34, as necessary. It is understood that hydraulic fluid may be any type of hydraulic fluid, such as hydraulic oil or the like.

FIG. 1 shows the drill string 28 located in hole 50 having a desired depth to a bottom 54 of hole 50. As shown by the arrows in FIG. 1, drill string 28 can rotate, and move up and down (e.g. feed and retract/hoist) such that drill bit 200 rotates and moves up and down, respectively. Drill bit 200 can also reciprocate in a rotational or up-and-down direction. Further, drill string 28 may include an air line for supplying compressed air from air compressor 36 to drill bit 200. Further, drill string 28 may include a water line (not shown) for supplying water through the drill bit 200 to hole 50.

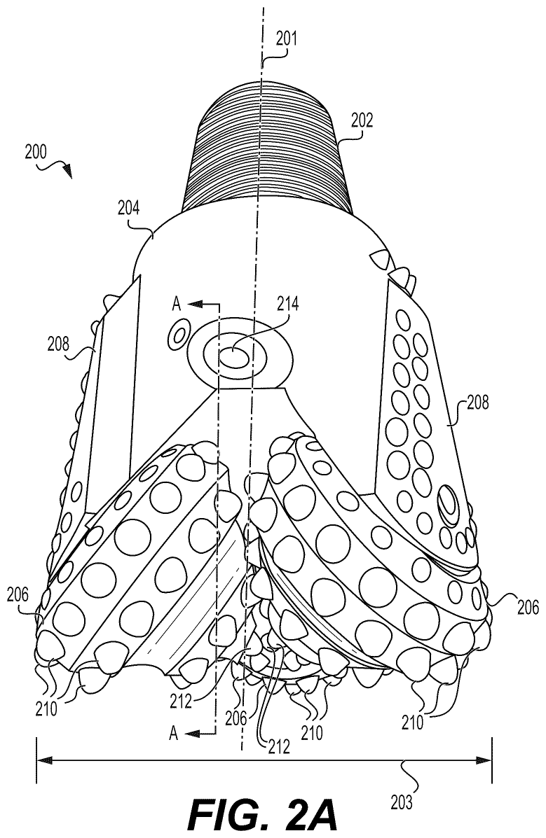

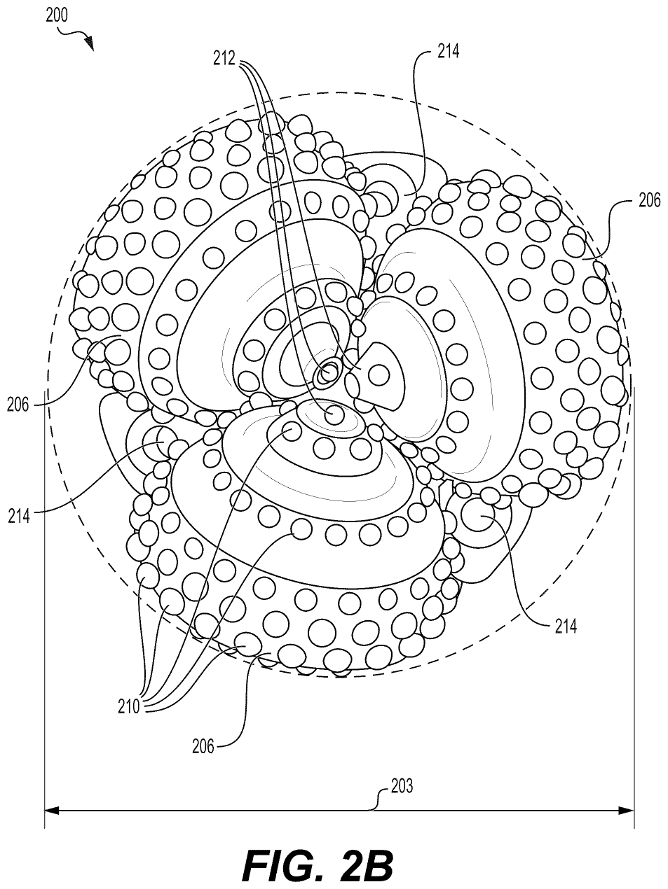

Referring now to FIGS. 2A and 2B, rotary drill bit 200 includes a body 204 and one or more rotating cones 206. An adapter 202 extends from a proximal end of body 204 and may include, for example, a threaded interface for connection to drill string 28 (FIG. 1). Body 204 extends from adapter 202 and supports cones 206. In particular, body 204 may include a plurality of legs 208 each rotatably supporting one of cones 206. Thus, the number of legs 208 is equal to the number of cones 206, which is three in the illustrated aspect (though other numbers of legs and cones such as two, four, or more are possible and within the scope of the present disclosure).

Cones 206 are generally conical in shape and include a plurality of cutting tips 210 extending radially and/or axially outward from the outer surfaces of cones 206. In various aspects, cutting tips 210 may be formed integrally with cones 206, or may be separate elements affixed to cones 206. Cutting tips 210 may be arranged so that the cutting tips 210 of adjacent cones 206 intermesh during rotation of cones 206 to improve cutting and grinding performance. In some aspects, each cone 206 may have a different arrangement of cutting tips 210. Cones 206 may be oriented such that distal tips 212 of the cones 206 point generally toward a longitudinal axis 201 of drill bit 200. Body 204 of drill bit 200 may further include one or more air nozzles 214 for directing air supplied by air compressor 36 of drilling machine 10 (see FIG. 1) at debris cut by cones 206.

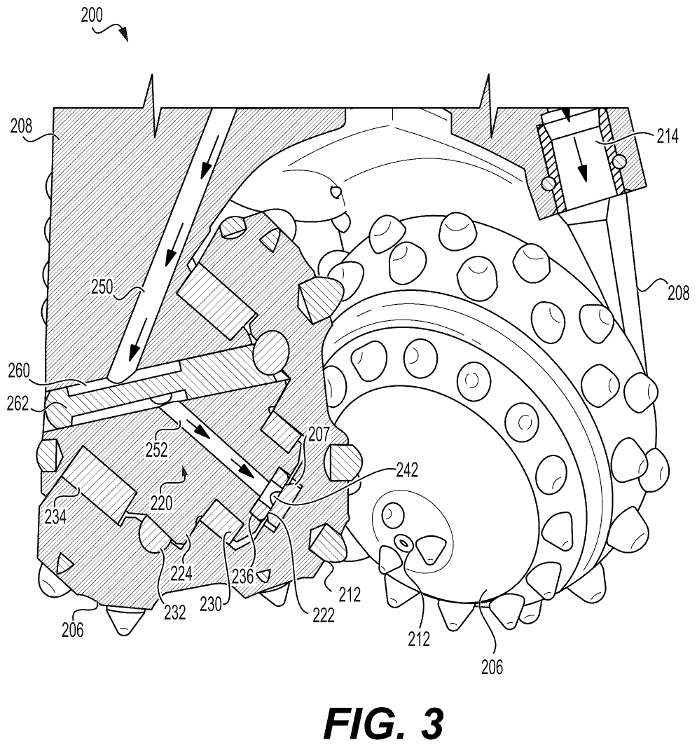

As shown in FIGS. 3 to 5, each leg 208 of body 204 defines a journal area 220 on which a respective cone 206 rotates. Journal area 220 supports one or more bearing assemblies that allow rotation of cone 206. In the illustrated aspect, journal area 220 includes a first bearing assembly including a plurality of cylindrical roller bearings 230 near distal tip 212 of cone 206, a second bearing assembly including a plurality of ball bearings 232 proximal to the first bearing assembly, and a third bearing assembly including plurality of cylindrical roller bearings 234 proximal to the second bearing assembly near a base of cone 206. First, second, and third bearing assemblies generally support radial loads from cone 206.

Journal area 220 further includes a thrust button 236 at a distal-most location of journal area 220 near the distal tip 212 of cone 206. Thrust button 236 supports axial thrust loads from a corresponding button 207 of cone 206. Thus, thrust button 236 acts as a first bearing surface 222. Journal area 220 further includes a second bearing surface 224 proximal of cylindrical roller bearings 230. Thus, cylindrical roller bearings 230 are located between first bearing surface 222 and second bearing surface 224, while ball bearings 232 and cylindrical roller bearings 234 are located proximal of second bearing surface. First bearing surface 222 and second bearing surface 224 support axial thrust loads from corresponding surfaces of cone 206.

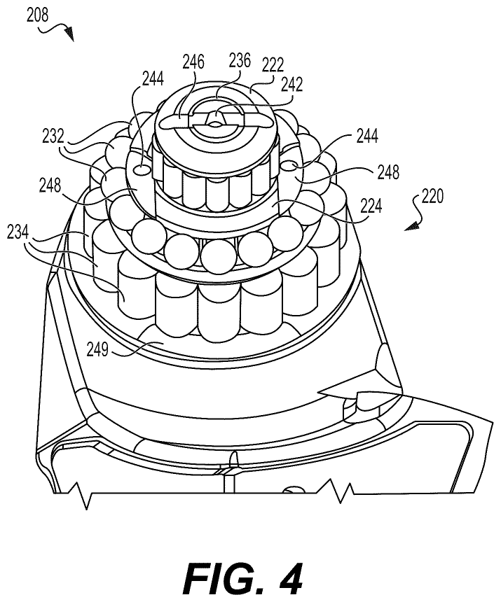

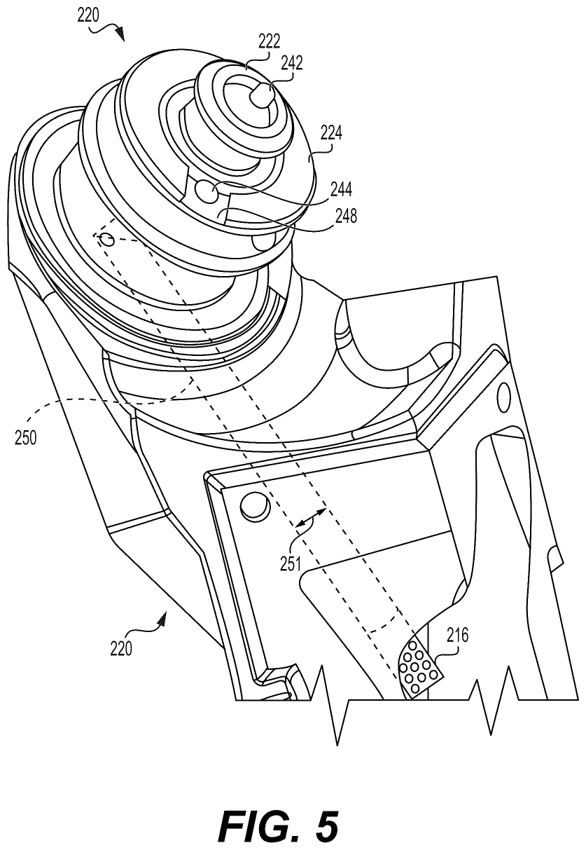

First bearing surface 222 and second bearing surface 224 may each include or be associated with one or more orifices through which air from air compressor 36 (see FIG. 1) may flow to journal area 220. In particular, a first air orifice 242 may extend at least partially through thrust button 236. In the aspect of FIGS. 3 and 4, first air orifice 242 is located substantially through the center of thrust button 236. In the aspect shown in FIGS. 5-7, first air orifice 242 extends through an outer edge of thrust button 236 (not shown in FIGS. 5-7) and an inner edge of the surrounding journal area 220. As shown in FIG. 4, first air orifice 242 opens into a transverse air passage 246 extending across the face of thrust button 236 and first bearing surface 222, allowing air from first air orifice 242 to flow outwardly to journal area 220. In the aspect of FIGS. 5-7, the off-axis location of first air orifice 242 allows air from first air orifice 242 to flow outwardly to journal area 220, making transverse air passage 246 unnecessary.

Leg 208 may include an insertion channel 260 through which ball bearings 232 may be inserted into journal area 220 after cone 206 is mounted to leg 208. A plug 262 may be inserted into insertion channel 260 to retain ball bearings 232 in place during operation of drill bit.

As shown in FIG. 4, for example, one or more second air orifices 244 open into second bearing surface 224. In some aspects, second air orifices 244 include two orifices that are regularly spaced apart (e.g., by approximately 180°) about centerline of journal area 220, though more or less orifices (e.g. one or greater than two) and other arrangements of the orifices, including orifices that are irregularly spaced apart, are within the scope of the present disclosure. Second air orifices 244 may be surrounded by exit passages 248 that allow air to exiting second air orifices 244 to flow out to journal area 220. Exit passages 248 are recessed surfaces formed into second bearing surface 224, and may extend partially around the circumference of second bearing surface 224. As shown in FIG. 4, journal area 220 may further include proximal exit passages 249 providing fluid communication between journal area 220 and the atmosphere outside of cone 206.

Referring now to FIGS. 5-7, each leg 208 of body 204 may include a primary conduit 250 within leg 208 that receives air from air compressor 36 (see FIG. 1) and that distributes the received air to air orifices 242, 244 via one or more journal conduits. Primary conduit 250 extends internally within leg 208, and has a dimeter or maximum cross-sectional width 251 (see FIG. 5). For example, primary conduit 250 may be formed integrally with the structure of leg 208. A proximal end of primary conduit 250, i.e. an end nearest adapter 202, may include an air plug 216 which is in fluid communication with nozzle 214 (see, e.g., FIG. 3). Air supplied from air compressor 36 is divided between nozzle 214 and primary conduit 250. Like primary conduit 250, nozzle 214 may extend from within leg 208. In some aspects, approximately 65-85% of incoming air from air compressor 36 flows to nozzle 214, and approximately 15-35% of incoming air flows to primary conduit 250. In some aspects, approximately 70% of incoming air from air compressor 36 flows to nozzle 214, and approximately 30% of incoming air flows to primary conduit 250.

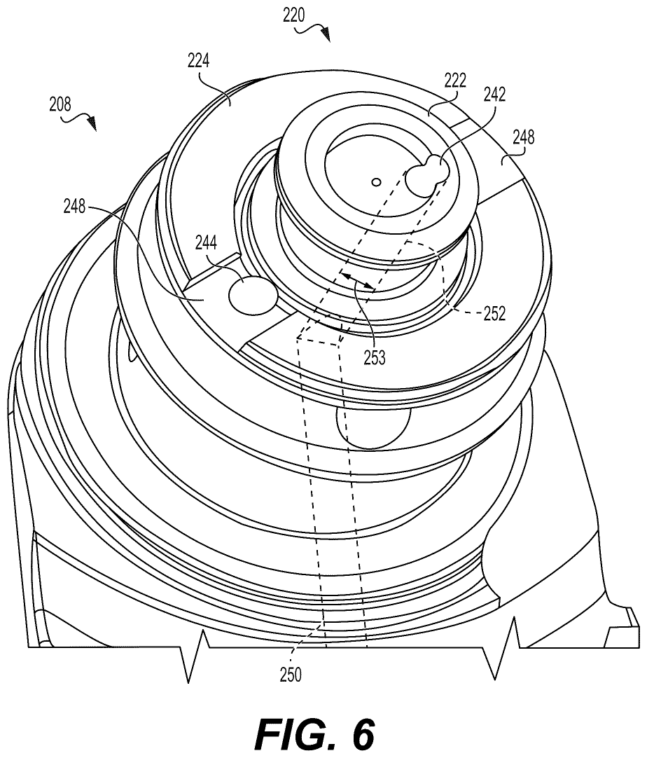

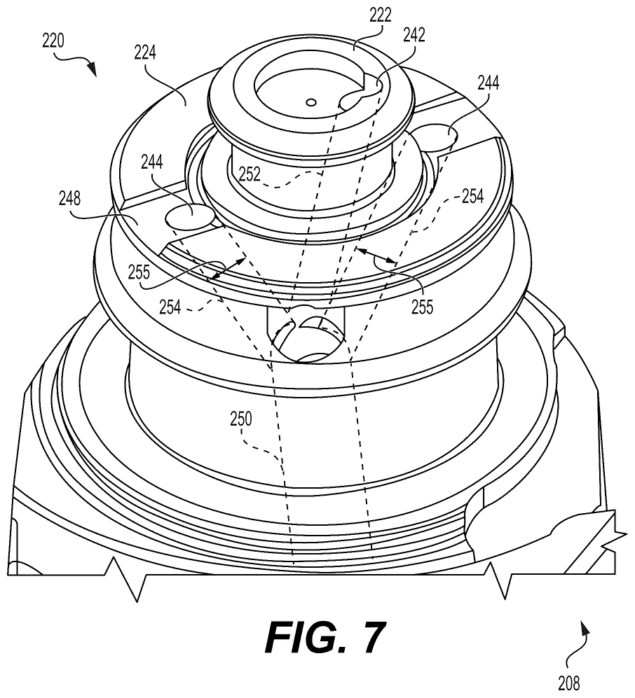

As shown in FIGS. 3, 6, and 7, a first journal conduit 252 extends from and is connected downstream of primary conduit 250 to first air orifice 242. First journal conduit 252 has a width or maximum cross-sectional diameter 253 (see FIG. 6). As shown in FIG. 7, second journal conduits 254 extend from and are connected downstream of primary conduit 250 to second air orifices 244. Second journal conduit 254 has a diameter or maximum cross-sectional width 255. First journal conduit 252 and second journal conduits 254 may extend generally from a distal end of primary conduit 250, i.e. the end farthest from adapter 202. First journal conduit 252 and second journal conduits 254 may extend internally within leg 208. For example, conduits 252, 254 may be formed integrally with the structure of leg 208. Primary conduit 250, first journal conduit 252, and second journal conduits 254 may extend generally linearly, as illustrated, or non-linearly in other aspects. Primary conduit 250, first journal conduit 252, and second journal conduit 254 may have generally circular cross sections, as illustrated, though other profiles such as oval, elliptical, polygonal, or the like may also be used.

Primary conduit 250, first journal conduit 252, and second journal conduits 254 may be sized in particular proportion to one another to balance the flow of air to various portions of journal area 220. In particular, the cross-sectional diameters of first journal conduit 252 and second journal conduits 254 may be sized in relation to another to ensure a sufficient volume and flow rate of cooling air reaches cylindrical roller bearings 230.

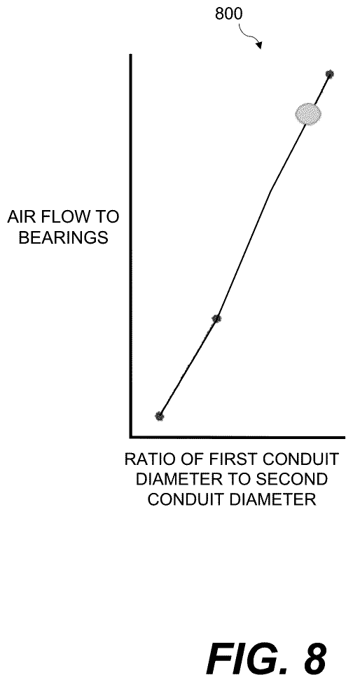

Referring now to FIG. 8, a graph 800 illustrates airflow to the cylindrical roller bearings 230 of drill bit 200 (shown on the ‘y’ axis, e.g., as a percentage) as a function of the ratio of the cross-sectional diameter 253 of the first journal conduit 252 to the cross-sectional diameter 255 of each of second journal conduits 254 (shown on the ‘x’ axis). The data for graph 800 corresponds to airflow simulations applied to a plurality of ratios of diameter 253 of first journal conduit 252 relative to diameter 255 of second journal conduits 254. Optimal air flow to cylindrical roller bearings 230 occurs when a ratio of cross-sectional diameter 253 of first journal conduit 252 relative to cross-sectional diameter 255 of second journal conduits 254 was in a range of 1 to 1.4 or a range of about 1 to about 1.4. That is, cross-sectional diameter 253 of first journal conduit 252 was 1 to 1.4 times greater than cross-sectional diameter 255 of each of (or one of) second journal conduits 254. In at least some embodiments, this ratio maximizes the overall air flow volume to cylindrical roller bearings 230.

Rotary drill bit 200 may be supplied in a plurality of sizes (i.e. industry standard sizes, such as 6¾″, 7⅞″, 9″, 9⅞″, 10⅝″, 11⅝″, 12¼″, 13¾″, 16″, etc.). The size of drill bit 200 may correspond to the widest cross-section (or diameter) 203 (see FIGS. 2A and 2B) of drill bit 200 (i.e. a width perpendicular to longitudinal axis 201 of drill bit 200). The cross-sectional diameter of the primary conduit 250, first journal conduit 252, and second journal conduits 254 may be optimized for a particular diameter 203 of drill bit 200 to maximize airflow to the cylindrical roller bearings 230 while balancing other factors such as airflow to other components of journal area 220 and structural integrity of legs 208. In one aspect, a size 12¼″ drill bit 200, primary conduit 250 has a diameter of about 20 millimeters (mm), first journal conduit 252 has a diameter of about 10 mm to about 13 mm, and second journal conduits 254 each have a diameter of about 8 mm to about 11 mm. In one example, for a size 12¼″ drill bit 200, primary conduit 250 has a diameter of about 20 mm, first journal conduit 252 has a diameter of about 12 mm, and second journal conduits 254 each have a diameter of about 10.5 mm. In this example, the ratio of diameter 253 of first journal conduit 252 to diameter 255 one of the second journal conduits 254 is 12:10.5, or 1.14, which falls within the optimal range of 1 to 1.4 described above. The cross-sectional diameter of primary conduit 250 may be sized to optimize air flow to journal area 220 as a whole. A ratio of diameter 203 of drill bit 200 relative to the cross-sectional diameter 251 of primary conduit 250 may be in a range of 13 to 16.5, or in a range of about 13 to about 16.5, or, in some aspects, in a range of about 14 to 16.5. That is, cross-sectional diameter 251 of primary conduit 250 may be 13 to 16.5 times less than diameter 203 (see FIGS. 2A and 2B) of drill bit 200. In at least some embodiments, this ratio is advantageous and maximizes the overall air flow volume to journal area 220 including the bearings. For example, for a 12¼″ (311.15 millimeter) diameter drill bit 200, the optimal diameter for primary conduit 250 is in a range of 18.8 to 24 mm.

It is noted that the aforementioned ratio of the diameters of first journal conduit 252 to second journal conduit 254 apply to multiple sizes of drill bit 200. That is, the ratio of diameter 253 of first journal conduit 252 to diameter 255 of second journal conduit 254 may be in a range of 1 to 1.4 for multiple drill bit sizes, not only the 12¼″ diameter used in the foregoing example. For example, the ratio of diameter 253 of first journal conduit 252 to diameter 255 of second journal conduit 254 may be in a range of 1 to 1.4 for 9⅞″ and 11⅝″ diameter drill bits. Similarly, the ratio of diameter 203 of drill bit 200 to diameter 251 of primary conduit 250 may in a range of 13 to 16.5 for drill bit sizes other than 12¼″.

As noted, the above-described ratio of diameters 253, 255 of first journal conduit 252 and second journal conduits 254 allow air flow to be maximized to cylindrical roller bearings 230 while balancing other factors (such as air flow to other components of journal area and/or structural integrity of legs 108) related to performance of drill bit 200.

Moreover, the ratio of diameter 203 of drill bit 200 relative to diameter 251 of primary conduit 250 within a range of about 13 to about 16.15 is advantageous in that air flow is maximized to journal area 220 while balancing other factors (such as structural integrity of legs 208) related to performance of drill bit 200. A ratio of less than 13 may compromise performance and/or strength of drill bit 200. Conversely, a ratio of greater than 16.5 may reduce air flow to journal area 220, which may result in damage to and/or shortened lifespan of drill bit 200.

### INDUSTRIAL APPLICABILITY

The disclosed aspects of rotary drill bit 200 may be used in conjunction with drilling machine 10 to drill into a substrate such as soil, clay, rock, or other substrate.

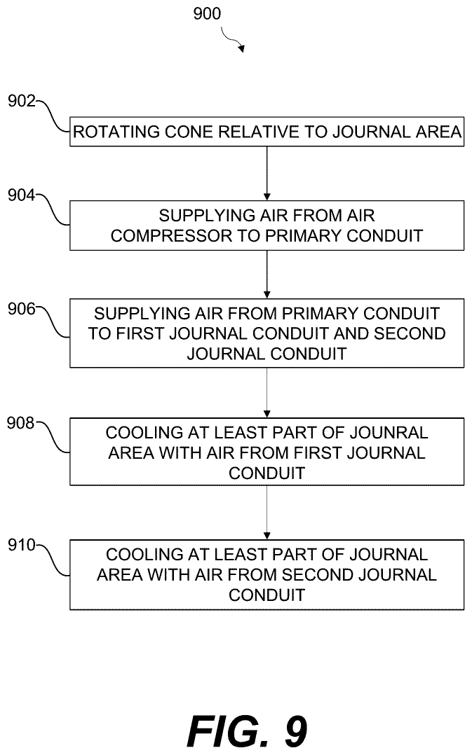

Referring now to FIG. 9, illustrated is a flow diagram illustrating an exemplary method 900 for operating rotary drill bit 200. At step 902, method 900 includes rotating cones 206 relative to journal area 220 (see FIG. 3). Rotation of cones 206 and downward pressure cuts into the substrate allowing drill bit 200 to advance downward. As noted above, cutting tips 210 of adjacent cones 206 may intermesh during rotation of cones 206.

At step 904, method 900 includes supplying air (or another gas) from air compressor 36 of drilling machine 10 to primary conduit 250. As described above, a proximal end of primary conduit 250 is in fluid communication with air compressor 36 via drill string 28, so air initially enters primary conduit 250 through the proximal end and flows toward the distal end thereof. Air may be supplied from air compressor 36 at, for example, about 30 psi to about 90 psi.

At step 906, method 900 includes supplying air from primary conduit 250 to first journal conduit 252 and second journal conduits 254. As described above, first journal conduit 252 and second journal conduits 254 are in fluid communication with primary conduit 250, so air entering primary conduit 250 automatically flows through primary conduit to first journal conduit 252 and second journal conduits 254.

At step 908, method 900 includes cooling at least part of journal area 220 with air from first journal conduit 252. In particular, air from first journal conduit 252 may flow out of first air orifice 242 to cool thrust button 236 and first bearing surface 222. The air from first journal conduit 252 may then flow outwardly and over cylindrical roller bearings 230, second bearing surface 224, ball bearings 232, and cylindrical roller bearings 234. Air may then proceed to escape to the atmosphere by flowing out from proximal exit passage 249 between journal area 220 and cone 206.

At step 910, method 900 includes cooling at least part of journal area 220 with air from second journal conduits 254. In particular, air from second journal conduits 254 may be flowed out of second air orifices 244 to cool second bearing surface 224. The air from second journal conduits 254 may then flow radially outwardly through exit passages 248 toward ball bearings 232 and cylindrical roller bearings 234. Air may then proceed to escape to the atmosphere by flowing out from proximal exit passages 249 between journal area 220 and cone 206.

Steps 908 and 910 may particularly provide effective cooling when the ratio of diameter 253 of first journal conduit 252 relative to diameter 255 of second journal conduits 254 is in the disclosed range of about 1 to about 1.4. In at least some embodiments, this ratio maximizes the overall air flow volume to cylindrical roller bearings 230. Further, steps 908 and 910 may particularly provide effective cooling when the ratio of diameter 203 of drill bit 200 relative to the diameter 251 of primary conduit 250 is in the disclosed range of about 13 to about 16.5. In at least some embodiments, this ratio is advantageous and maximizes the overall air flow volume to journal area 220 including the bearings.

It should be appreciated that while steps 902-910 are described and illustrated in an exemplary sequence, any or all of steps 902-910 may be performed substantially concurrently, in an overlapping manner, and/or in a different order. Further, steps 904-910 may be performed automatically, i.e., without additional intervention, when air is supplied to drill bit 200 from air compressor 36 of drilling machine 10.

Rotary drill bit 200 of the present disclosure may exhibit improved cooling and therefore longer life due to the particular ratio of diameter 253 of first journal conduit 252 relative to diameter 255 of second journal conduits 254 described herein. In particular, the disclosed ratio of about 1 to about 1.4 may maximize the volume of cooling air supplied to cylindrical roller bearings 230.

The cylindrical roller bearings 230 are particularly susceptible to accelerated wear and failure because the cylindrical roller bearings 230 are physically smaller than the cylindrical roller bearings 234. Additionally, there are fewer cylindrical roller bearings 230 compared to cylindrical roller bearings 234, meaning each cylindrical roller bearing 230 supports a relatively greater load. Further, cylindrical roller bearings 230 are located farthest from primary conduit 250 out of all bearings 230, 232, 234, meaning air must travel farther to reach cylindrical roller bearings 230. Still further, temperatures of drill bit 200 are at a maximum in the region surrounding cylindrical roller bearings 230 due to the design of drill bit 200, particularly due to the frictional heat generated by first and second bearing surfaces 222, 224 and cylindrical roller bearings 230. Cylindrical roller bearings 230 therefore receive significant benefits from additional cooling.

This additional cooling may be achieved using the disclosed ratio of the diameter 253 of first journal conduit 252 to the diameter 255 of second journal conduits 254 (particularly the ratio of about 1 to about 1.4), which mitigates these issues associated with cylindrical roller bearings 230, while still providing sufficient air flow to other components of journal area 220 to prevent premature wear and failure of those components. In particular, a ratio of at least 1 provides desired air flow to cylindrical roller bearings 230, while a ratio no more than 1.4 ensures that other components of journal area 220 receive sufficient cooling air to avoid premature failure.

Still further, cooling may be enhanced using the disclosed ratio of diameter 203 of drill bit 200 relative to the diameter 251 of primary conduit 250 in the range of about 13 to about 16.5. This conduit ratio may maximize the volume of cooling air supplied to journal area 220, including thrust button 236, first bearing surface 222, cylindrical roller bearings 230, second bearing surface 222, ball bearings 232, and cylindrical roller bearings 234. Moreover, the disclosed conduit ratio maintains sufficient air velocity exiting first air orifice 242 and second air orifices 244 to ensure a flow of cooling air across entire journal area 220. Thus, cooling air does not stagnate in journal area 220, but rather continues to flow across journal area 220 and out proximal exit passages 249 as fresh cooling air is supplied from air compressor 36.

It will be apparent to those skilled in the art that various modifications and variations can be made to the disclosed system and method without departing from the scope of the disclosure. Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A rotary drill bit for a drilling system including a drilling machine having an air compressor to supply air to the rotary drill bit, the rotary drill bit comprising:
a plurality of rotating cones each comprising a plurality of cutting tips; and
a plurality of legs on which the plurality of cones are respectively supported, each leg comprising:
a journal area configured to rotatably support the respective cone;
a primary conduit extending internally within the leg and configured to receive air from the air compressor;
a first journal conduit downstream from the primary conduit and extending to a first air orifice of the journal area; and
at least one second journal conduit downstream from the primary conduit and extending to at least one corresponding second air orifice of the journal area,
wherein a ratio of a cross-sectional diameter of the first journal conduit to a cross-sectional diameter of at least one of the second journal conduits is in a range of about 1 to about 1.4.

2. The rotary drill bit of claim 1, wherein a ratio of the diameter of the rotary drill bit relative to a cross-sectional diameter of the primary conduit is in a range of about 13 to about 16.5.

3. The rotary drill bit of claim 1, wherein each leg further comprises a plurality of cylindrical roller bearings on which the cone rotates, wherein the cylindrical roller bearings are located between a first bearing surface comprising the first air orifice and a second bearing surface comprising the at least one second air orifice.

4. The rotary drill bit of claim 1, wherein the at least one second journal conduit comprises two second journal conduits.

5. The rotary drill bit of claim 1, wherein the journal area comprises a thrust button, and
wherein the first air orifice extends at least partially through the thrust button.

6. The rotary drill bit of claim 1, wherein the journal area comprises a plurality of bearings radially supporting the cone, and
wherein the at least one second orifice is provided in a bearing surface proximal to the plurality of bearings.

7. The rotary drill bit of claim 1, wherein the at least one second orifice is surrounded by an exit passage that is recessed into a bearing surface of the journal area.

8. The rotary drill bit of claim 1, further comprising a nozzle extending from within each of the legs such that air received from the air compressor is divided between the nozzle and the primary conduit.

9. The rotary drill bit of claim 8, further comprising an air plug in fluid communication with the nozzle.

10. The rotary drill bit of claim 1, wherein the primary conduit has a diameter of about 18.8 millimeters to about 24 millimeters, the first journal conduit has a diameter of about 10 millimeters to about 13 millimeters, and each of the second journal conduits have a diameter of about 8 millimeters to about 11 millimeters.

11. A method for operating a rotary drill bit including a cone rotatably supported on a leg, the method comprising:
rotating the cone relative to a journal area of the leg;
supplying air from an air compressor to a primary conduit within the leg;
supplying air from the primary conduit to a first journal conduit and a second journal conduit within the leg;
cooling at least part of the journal area with air from the first journal conduit; and
cooling at least part of the journal area with air from the second journal conduit,
wherein a ratio of a cross-sectional diameter of the first journal conduit to a cross-sectional diameter of the second journal conduit is in a range of about 1 to about 1.4.

12. The method of claim 11, wherein a ratio of a diameter of the rotary drill bit relative to a cross-sectional diameter of the primary conduit is in a range of about 13 to about 16.5.

13. The method of claim 11, wherein the cone rotates on a plurality of cylindrical roller bearings located between a first bearing surface and a second bearing surface, wherein the first bearing surface comprises a first air orifice connected to the first journal conduit, and wherein the a second bearing surface comprises a second air orifice connected to the second journal conduit.

14. The method of claim 11, wherein cooling at least part of the journal area with air from the first journal conduit comprises flowing air from the first journal conduit out of an air orifice extending at least partially through a thrust button of the journal area.

15. The method of claim 11, wherein cooling at least part of the journal area with air from the first journal conduit comprises flowing air over a plurality of bearings of the journal area.

16. The method of claim 11, wherein cooling at least part of the journal area with air from the second journal conduit comprises flowing air from the second journal conduit out of an air orifice in a bearing surface of the journal area.

17. The method of claim 16, wherein cooling at least part of the journal area with air from the second journal conduit comprises flowing air radially outward from an exit passage surrounding the air orifice.

18. A drilling system comprising:
a drilling machine comprising an air compressor;
a drill string extending from the drilling machine; and
a rotary drill bit connected to an end of the drill string and receiving air from the air compressor via the drill string, the rotary drill bit comprising:
a plurality of legs each comprising:
a journal area configured to rotatably support a cone;
a primary conduit extending internally within the leg and configured to receive air from the air compressor;
a first journal conduit downstream from the primary conduit and extending to a first air orifice of the journal area; and
a second journal conduit downstream from the primary conduit and extending to a second air orifice of the journal area,
wherein a ratio of a cross-sectional diameter of the first journal conduit to a cross-sectional diameter of the second journal conduit is in a range of about 1 to about 1.4.

19. The drilling system of claim 18, wherein a ratio of a diameter of the rotary drill bit relative to a cross-sectional diameter of the primary conduit is in a range of about 13 to about 16.5.

20. The drilling system of claim 18, wherein each leg further comprises a plurality of cylindrical roller bearings on which the cone rotates, wherein the cylindrical roller bearings are located between a first bearing surface comprising the first air orifice and a second bearing surface comprising the second air orifice.
